(19) United States
(12) Patent Application Publication
(10) Pub. No.: US 2022/0194697 A1
(43) Pub. Date: Jun. 23, 2022

(54) WASTE TRANSPORTING MOBILE UNIT AND WASTE COLLECTION SYSTEM

(71) Applicant: TOYOTA JIDOSHA KABUSHIKI KAISHA, Toyota-shi Aichi-ken (JP)

(72) Inventors: Katsuhisa Yoshikawa, Miyoshi-shi Aichi-ken (JP); Shigeru Inamori, Nagoya-shi (JP); Mitsuyoshi Ohno, Miyoshi-shi (JP); Kosuke Sakakibara, Toyota-shi Aichi-ken (JP); Nao Yamamoto, Chiyoda-ku Tokyo (JP); Shinpei Yasukawa, Chiyoda-ku Tokyo (JP); Katsuhito Yamauchi, Seto-shi Aichi-ken (JP); Hiroaki Namba, Toyota-shi Aichi-ken (JP); Tatsuya Ono, Yokohama-shi Kanagawa-ken (JP)

(21) Appl. No.: 17/550,691

(22) Filed: Dec. 14, 2021

(30) Foreign Application Priority Data
Dec. 17, 2020 (JP) 2020-209667

(51) Int. Cl. B65F 1/14; G05D 1/02

(52) U.S. Cl. CPC B65F 1/1473; G05D 1/0274; B65F 2210/128; B65F 2210/1443; G05D 1/0225

(57) ABSTRACT

A waste transporting mobile unit includes a waste container that collects waste, a sensor configured to sense the amount of waste accumulated in the waste container, and a travel device configured to travel when the amount of waste sensed by the sensor reaches a predetermined amount.

### CROSS REFERENCE TO RELATED APPLICATION

This application claims priority to Japanese Patent Application No. 2020-209667 filed on Dec. 17, 2020, which is incorporated herein by reference in its entirety including the specification, claims, drawings, and abstract.

### TECHNICAL FIELD

The present disclosure relates to a structure of a waste transporting mobile unit in a predefined area and a waste collection system for collecting waste.

### BACKGROUND

Waste collection systems that achieve effective collection of waste have been disclosed. Some of such systems predict time when the amount of waste accumulated in a waste container will reach a predetermined amount based on data that show an hourly increase of waste placed in the waste container (refer to, for example, JP 2017-30920 A).

### SUMMARY

In the system disclosed in JP 2017-30920 A, a waste truck should go to a site where a waste container is located to collect waste. Some space is thus required for executing the waste collecting work, and views around the site may be degraded during the waste collecting work.

An object of the present disclosure is to provide a waste transporting mobile unit and a waste collection system that can collect waste without degrading views.

A waste transporting mobile unit according to the present disclosure includes a waste container that collects waste, a sensor that is configured to sense the amount of waste accumulated in the waste container, and a travel device that is configured to travel when the amount of waste sensed by the sensor reaches a predetermined amount.

This can eliminate waste collecting work at a site where the waste transporting mobile unit is located, and thus reduce degradation of views around the site.

The waste transporting mobile unit according to the present disclosure may further include an indicator that is configured to indicate the amount of waste sensed by the sensor. The indicator may change an indicated status in accordance with the amount of waste sensed by the sensor.

This enables people around the waste transporting mobile unit to easily recognize the amount of waste accumulated in the mobile unit, and thus reduces risks of overload of the waste container.

A waste transporting mobile unit according to the present disclosure includes a waste container that collects waste, a communication device that is configured to receive information from an external entity, and a travel device that is configured to travel in accordance with the information received by the communication device.

As this can enable allocation of the waste container based on information sent from an external entity, effective collection of waste can be achieved.

A waste collection system includes a server that includes a topographic database that stores topographic information of a predefined area, a waste container that collects waste, and a sensor that is configured to sense, as waste amount information, the amount of waste accumulated in the waste container, and a mobile unit that is configured to communicate with the server to travel within the predefined area. The mobile unit is configured to send, to the server, the waste amount information sensed by the sensor. The server is configured to output a travel command to the mobile unit based on the waste amount information received from the mobile unit.

Based on the waste amount information, the mobile unit including the waste container for collecting waste is instructed to traveled to, for example, a waste collection station before waste overflows from the waste container. This can reduce degradation of views in the predefined area. Also, as the mobile unit including the waste container for collecting waste can autonomously travel to transport waste, no waste collecting work from the waste container in the predefined area is required. This can also reduce the view degradation.

The waste collection system according to the present disclosure may include an establishment that is located in the predefined area and configured to communicate with the server to output waste discharge information to the server. The server may be configured to output a travel command to the mobile unit based on the waste discharge information received from the establishment.

As the mobile unit can be allocated based on the waste discharge information received from an establishment, such as a food court, in the predefined area as described above, when the amount of waste discharged from the establishment increases, another mobile unit with an empty waste container can be allocated to the establishment to reinforce a waste collection capacity. This enables effective collection of waste, reducing degradation of views.

In the waste collection system according to the present disclosure, the server may include a waste discharge amount database in which a past waste discharged amount in the predefined area is stored with association with a time slot, a season, and/or weather conditions. The server may be configured to output a travel command to the mobile unit based on the waste discharge amount database.

As this can enable adjustment of the allocation and operation of the mobile units in the predefined area in accordance with the time slot, the season, and/or the weather conditions, waste can be effectively collected.

In the waste collection system according to the present disclosure, the travel command may be a relocation command to a predetermined location. The mobile unit may autonomously travel to the predetermined location based on topographic data of the predefined area and location information of the predetermined location received from the server.

As the mobile unit itself calculates a travel route from the current location to the predetermined location, a load to the server can be reduced.

In the waste collection system according to the present disclosure, the travel command may include a travel route to a predetermined location. The mobile unit may autonomously travel to the predetermined location based on the travel route received from the server.

As the server calculates the travel route and sends the calculated travel route to the mobile unit, the mobile unit itself does not calculate the travel route. This can simplify the configuration of the mobile unit.

In the waste collection system according to the present disclosure, the mobile unit may include an indicator that is configured to indicate the amount of waste sensed by the sensor. The indicator may be configured to change an indicated status in accordance with the amount of waste sensed by the sensor.

This enables people around the mobile unit to easily recognize the amount of waste accumulated in the waste container, and thus reduces risks of overload of the waste container.

The present disclosure can provide a waste transporting mobile unit and a waste collection system that can collect waste without degrading views.

### BRIEF DESCRIPTION OF DRAWINGS

Embodiments of the present disclosure will be described based on the following figures, wherein:

FIG. 1 is a perspective view of a waste transporting mobile unit according to an embodiment of the present disclosure;

FIG. 2 is a system diagram of a waste collection system according to an embodiment of the present disclosure;

FIG. 3 is a functional block diagram of the waste collection system according to an embodiment of the present disclosure;

FIG. 4 is a graph showing transitions of a waste discharge amount from a food court in time slots stored in a waste discharge amount database;

FIG. 5 is a graph showing transitions of a waste discharge amount from an attraction in time slots stored in the waste discharge amount database; and

FIG. 6 is an explanatory diagram showing operations of the waste collection system according to an embodiment of the present disclosure.

### DESCRIPTION OF EMBODIMENTS

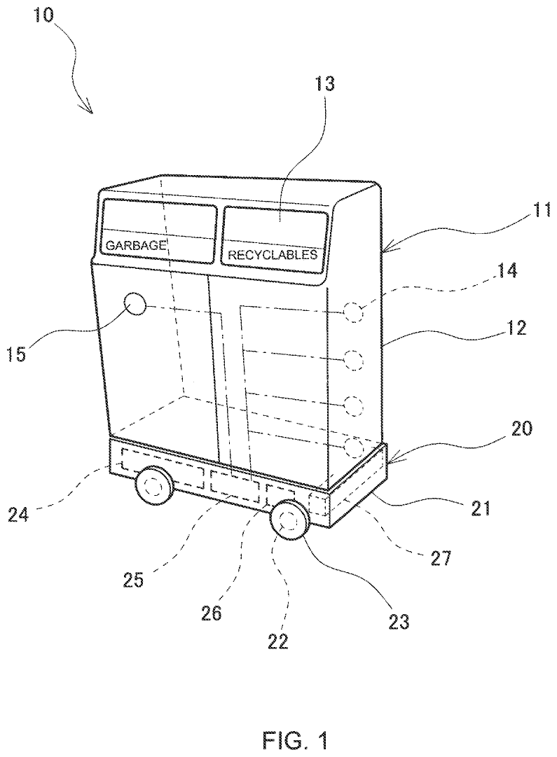

A waste transporting mobile unit 10 (also referred to as a “mobile unit 10”) according to an embodiment of the present disclosure is described below with reference to the attached drawings. As shown in FIG. 1, each waste transporting mobile unit 10 includes a waste container 11 for collecting waste, at least one sensor 14 that senses the amount of waste accumulated in the waste container 11, an indicator 15, and a travel device 20.

The waste container 11 includes a body 12 for collecting waste and at least one opening 13 through which waste is put into the body 12. The waste container 11 is mounted on the travel device 20 so as to travel together with the travel device 20. The at least one sensor 14 is attached to the body 12 of the waste container 11 to sense the amount of waste accumulated in the body 12. The sensor 14 may be a sensing device of any type, so long as the sensor 14 can sense the volume or weight of waste accumulated inside. In the case of the volume sensing type, the sensor 14 may emit infrared radiation inside the body 12, and sense whether the waste is accumulated up to the height of the sensor 14 based on whether or not the sensor 14 receives reflected radiation. Multiple sensors 14 may be vertically lined up to sense the amount of waste based on the height of the accumulated waste. In the example shown in FIG. 1, the first uppermost sensor 14 is attached at a height where the waste container 11 becomes full (100% of the capacity) with waste, and second to fourth sensors 14 from the top are respectively attached at heights indicating the amount of waste reaching 75%, 50%, and 25% capacity of the waste container 11.

The indicator 15 may be attached at the front of the body 12. The indicated status of the indicator 15 may change in accordance with the amount of waste accumulated in the waste container 11.

The travel device 20 is an electric travel device that autonomously travels with drive wheels 23 driven by drive motors 22. The travel device 20 includes a casing 21, the drive motors 22, the drive wheels 23, a battery 24, a travel controller 25, a location sensor 26, and a communication device 27. The battery 24, the travel controller 25, the location sensor 26, and the communication device 27 are enclosed in the casing 21.

Each drive motor 22 is an in-wheel motor that is incorporated in the drive wheel 23. The battery 24 supplies drive electric power to the drive motors 22. The location sensor 26 senses the location of the mobile unit 10 using a GPS unit, calculates a travel route from a current location to a destination based on topographic data, and outputs the calculated travel route to the travel controller 25. The travel controller 25 controls autonomous traveling of the travel device 20 by controlling the motor speed and the torque of the drive motors 22 and the orientation of the drive wheels 23 based on the location information and the travel route input by the location sensor 26. The travel controller 25 includes a computer with a processor that may be a CPU for performing information processing, and a memory. The communication device 27 is connected to the travel controller 25 to send and receive information to/from an external entity. The communication device 27 may be incorporated in or separated from the travel device 20.

Each of the sensors 14 attached to the waste container 11 is connected to the travel controller 25 of the travel device 20 such that the amount information of waste accumulated in the waste container 11 sensed by the sensor 14 is input to the travel controller 25. The indicator 15 attached to the waste container 11 is also connected to the travel controller 25 such that the indicated status changes in accordance with a command from the travel controller 25.

Operations of the mobile unit 10 having the above configuration are described below. The waste transporting mobile unit 10 may be stationed beside a food service establishment from which waste is discharged. When the waste transporting mobile unit 10 is stationed, customers of the food service establishment can place waste into the body 12 through the opening 13 of the waste container 11. The sensor 14 continuously senses the amount of waste accumulated in the body 12.

When waste accumulates to the height of the sensor 14 attached to the body 12 of the waste container 11, the sensor 14 outputs a waste detection signal to the travel controller 25. When multiple sensors 14 are provided as shown in FIG. 1, each sensor outputs the waste detection signal to the travel controller 25 when waste accumulates to the height of the sensor 14. Upon receipt of the waste detection signal from the uppermost sensor 14 of the waste container 11, the travel controller 25 determines that the amount of waste accumulated in the waste container 11 has reached a predetermined amount, and starts traveling of the waste transporting mobile unit 10. The predetermined amount of waste to trigger the travel may be set as required. For example, when the amount is set to 100%, the travel controller 25 starts traveling of the mobile unit 10 upon receipt of the waste detection signal from the uppermost sensor 14 shown in FIG. 1. When the amount is set to 75%, the travel controller 25 starts the travel upon receipt of the waste detection signal from the second highest sensor 14 shown in FIG. 1.

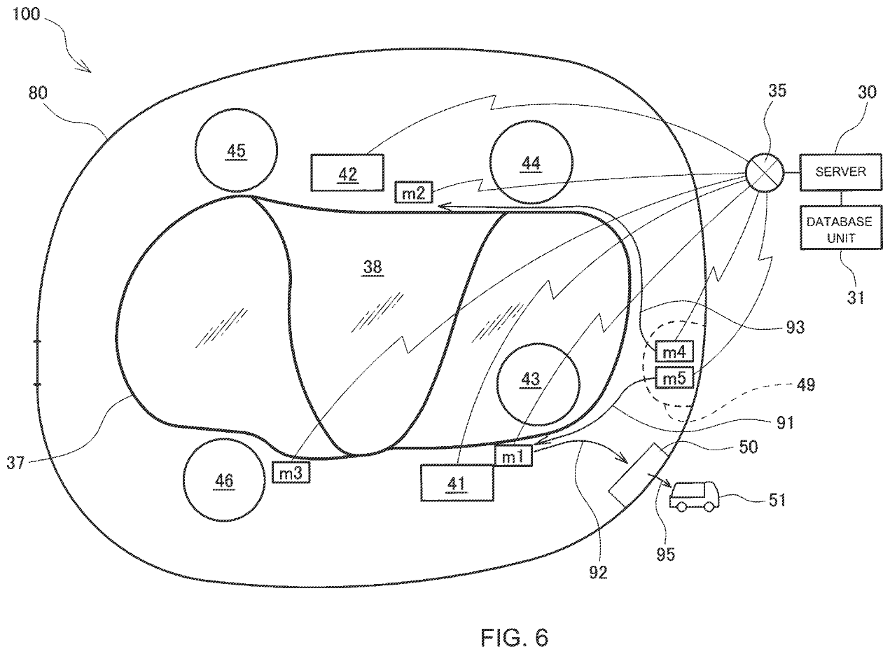

The waste transporting mobile unit 10 may travel to, for example, a waste collection station 50, where the waste in the waste container 11 is discharged (refer to FIG. 6). The waste collection station 50 is a facility where waste from the waste transporting mobile unit 10 is transiently retained before being loaded into a waste collecting truck 51 as scheduled.

Upon receipt of the waste detection signal from the lowest sensor 14, the travel controller 25 may illuminate the indicator 15, for example, in green. Upon receipt of the waste detection signal from each of the second lowest to the uppermost sensor 14, the travel controller 25 may change the illumination color of the indicator 15, for example, in the order of yellow, orange, and red.

As described above, because the mobile unit 10 moves from the site where the mobile unit 10 is located when the amount of waste accumulated in the waste container 11 reaches a predetermined amount, no waste collecting work is executed at the site. This can reduce degradation of views. Because the illumination color of the indicator 15 changes in accordance with the amount of waste, people around the mobile unit 10 can easily recognize the amount of waste accumulated in the mobile unit 10. This can reduce the risk of overload of the waste container 11.

Other operations of the mobile unit 10 are described below. The mobile unit 10 may be controlled to start traveling to, for example, a food service establishment upon receipt of information indicating an increase in waste discharged from the food service establishment. In this way, because the mobile unit 10 with the empty waste container 11 can be arranged to travel to a site where the amount of waste is increasing, waste can be effectively collected.

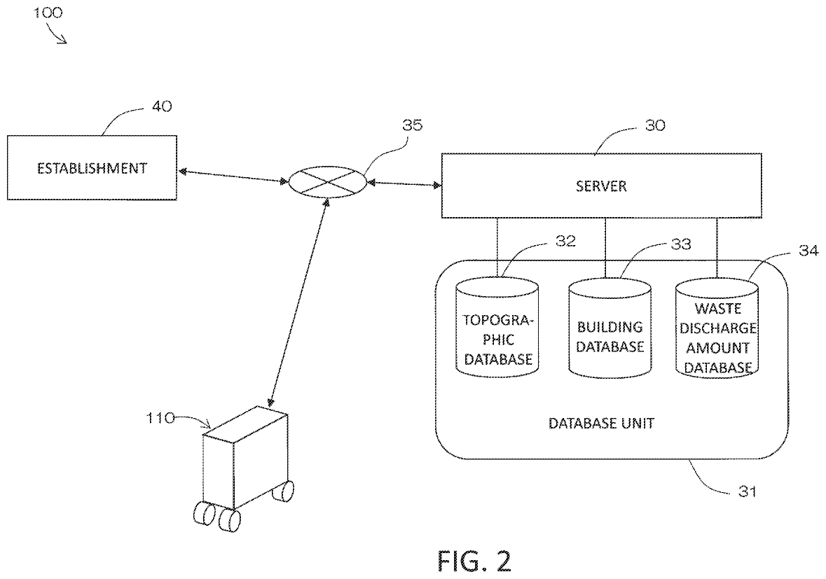

A waste collection system 100 using a waste transporting mobile unit 110 (also referred to as a “mobile unit 110”) is described below with reference to FIGS. 2 to 6. As shown in FIG. 2, the waste collection system 100 includes a server 30, the mobile unit 110, and an establishment 40. The mobile unit 110 communicates with the server 30 via a communication line 35 to travel within a predefined area in accordance with a travel command from the server 30.

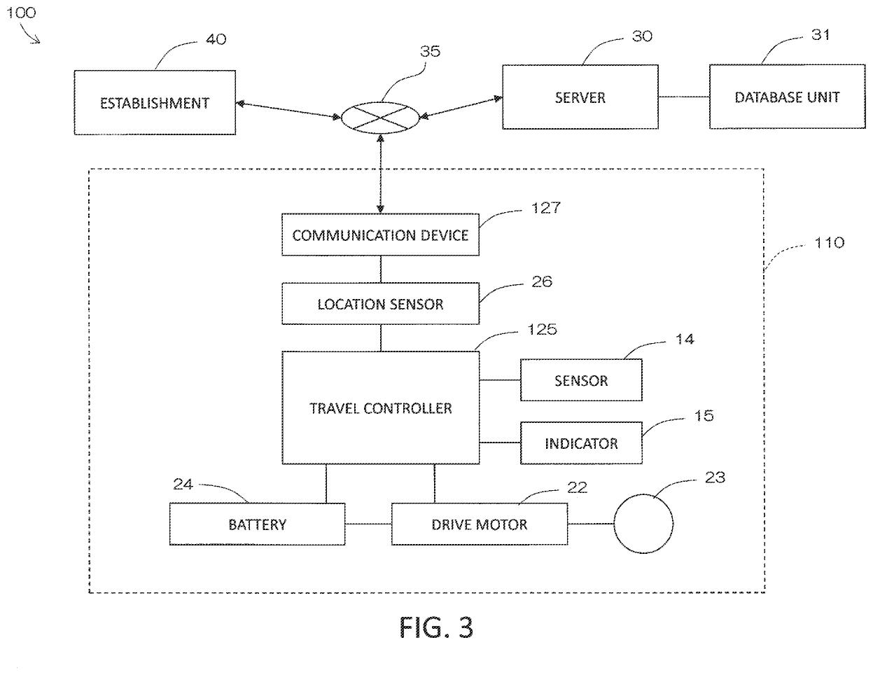

FIG. 3 is a functional block diagram which shows a configuration of the mobile unit 110. As shown in FIG. 3, the mobile unit 110 includes a travel controller 125, the location sensor 26, a communication device 127, at least one sensor 14, the indicator 15, the battery 24, the drive motors 22, and the drive wheels 23. The location sensor 26, the sensors 14, the indicator 15, the battery 24, the drive motors 22, and the drive wheels 23 are the same as the ones used for the mobile unit 10 described above with reference to FIG. 1. As such, the same reference numerals are used and their repeated descriptions are omitted.

The communication device 127 receives and sends data from/to the server 30 via the communication line 35.

The travel controller 125 controls autonomous traveling of the mobile unit 110 to a destination by controlling the motor speed and the torque of the drive motors 22 and the orientation of the drive wheels 23 based on location information and a travel route input from the location sensor 26.

Upon receipt of each waste detection signal from one of the multiple sensors 14 described above with reference to FIG. 1, the travel controller 125 calculates the amount of waste accumulated in the waste container 11 in accordance with the position of the sensor 14 which has outputted the waste detection signal, and generates the waste amount information. For example, upon receipt of the waste detection signal from the lowest sensor 14 shown in FIG. 1, the travel controller 125 determines that the amount of waste accumulated in the waste container 11 has reached 25% of the capacity of the waste container 11, and generates the waste amount information of 25% accordingly. Similarly, upon receipt of the waste detection signal from each of the second lowest to the uppermost sensor 14, the travel controller 125 generates the waste amount information of 50%, 75%, and 100% respectively. The travel controller 125 outputs the generated waste amount information to the communication device 127, which sends the waste amount information received from the travel controller 125 to the server 30 via the communication line 35.

The establishment 40 may be a facility, building, or the like located within the predefined area. The establishment 40 receives and sends data from/to the server 30 via the communication line 35. The predefined area is not limited to any specific area, and may be one block in a town, a park, or a theme park 80 shown in FIG. 6. The theme park 80 may be an amusement facility that bases a specific theme such as an aspect of culture, a country, a story, a movie, an era, or the like. The theme park 80 may include the establishments 40, such as food courts 41, 42, and attractions 43 to 46.

Referring back to FIG. 2, the server 30 is a computer that includes a CPU for processing information, and a memory. The server 30 is connected to a database unit 31 that includes a topographic database 32, a building database 33, and a waste discharge amount database 34.

The topographic database 32 stores topographic information in a predefined area about roads 37, establishments 40, sidewalks, and places where the mobile unit 10 is allowed to travel.

The building database 33 stores interior data of each building in a predefined area, such as a floor layout, the locations of vertical transportation facilities, such as elevators and escalators, and the locations of fixtures and partitions on each floor. The building database 33 may be, for example, a combination of building information molding (BIM) data of each building and scanned data of the inside of the building.

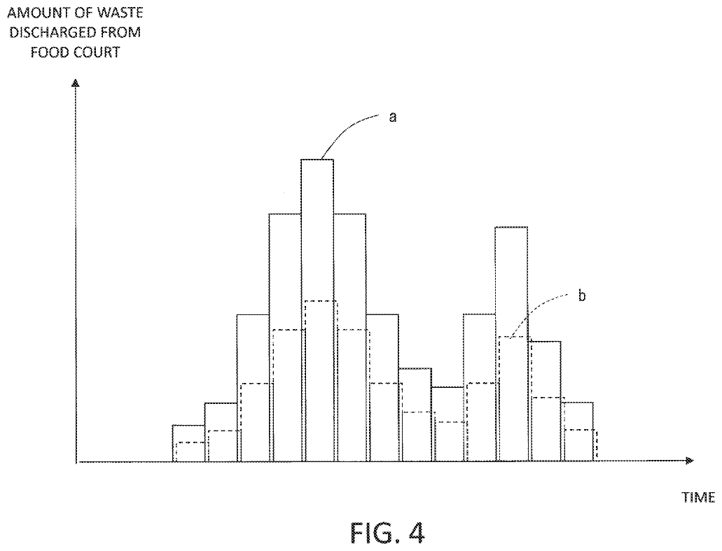

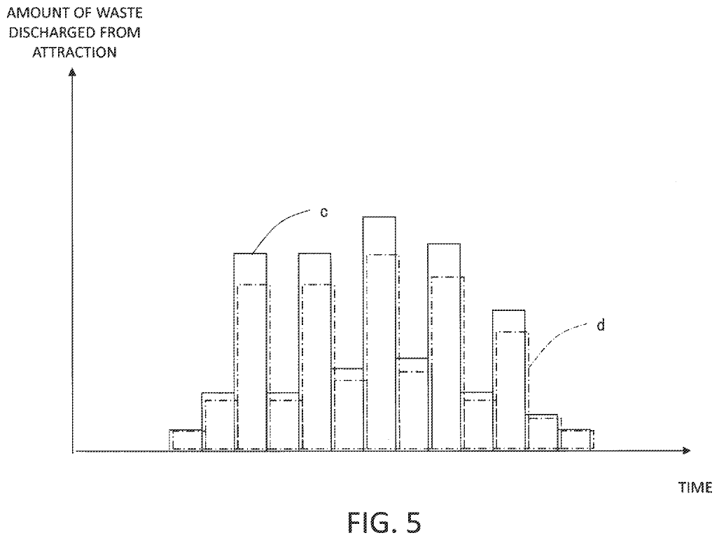

The waste discharge amount database 34 stores a past amount of waste discharged from each establishment 40 in a predefined area in association with a time slot, a season, and/or weather conditions. FIGS. 4 and 5 show exemplary data stored in the waste discharge amount database 34 when the waste collection system 100 is applied to the theme park 80 shown in FIG. 6.

FIG. 4 is a bar graph that shows a change in the amount of waste discharged from the food courts 41, 42 in respective time slots. The solid-line bars “a” show a change in the amount of discharged waste on a fine day, whereas the broken-line bars “b” show the change on a rainy day. As shown with the solid-line bars “a”, the amount of waste discharged from the food courts 41, 42 is larger at lunch time around the noon and dinner time in the evening than at an earlier time in the morning or in the time slots between lunch and dinner. As shown with the broken-line bars “b”, the amount of discharged waste is smaller in every time slot on the rainy day, with fewer visitors to the theme park 80, than those on the fine day shown with the solid-line bars “a”.

FIG. 5 is a bar graph that shows a change in the amount of waste discharged from the attractions 43 to 46 in respective time slots. The solid-line bars “c” in FIG. 5 show the amount of discharged waste on a fine day, whereas the dash-dot-line bars “d” show the amount on a rainy day. As shown with the solid bars “c” in FIG. 5, the amount of waste discharged from the attractions 43 to 46 is smaller during an event than in the time slots between events, when visitors are likely to have snacks or drink beverages. Similarly to the food courts 41, 42, the amount of discharged waste is smaller on the rainy day shown with the dash-dot lines “d” than those on the fine day.

The operations of the waste collection system 100 with the above configurations are described below with reference to FIG. 6. In the description below, the waste collection system 100 is assumed to be applied to the theme park 80. As described above, the theme park 80 includes the establishments 40, such as the food courts 41, 42, and the attractions 43 to 46. Multiple mobile units 110 travel in the theme park 80. When referring separately to one of the individual mobile units 110, each mobile unit is referred to as a mobile unit m1, m2, m3, m4, or m5, whereas when referring without distinction, they are referred as the mobile unit 110. The mobile units m1 to m5 communicate with the server 30 via the communication line 35 to travel on the roads 37 in the theme park 80. The mobile units m1 to m5 may travel in an open space 38 and on lawns. The theme park 80 includes an allocating station 49 where the mobile units 110 with empty waste containers 11 are stationed.

The theme park 80 may include the waste collection station 50 located around the periphery of the theme park 80. The waste collection station 50 is a facility to transiently retain waste collected by the mobile units m1 to m5 until the waste collecting truck 51 comes from outside to pick-up the waste.

In the mornings before the opening of the theme park 80, the mobile unit m1 may be located beside the food court 41; the mobile unit m2 beside the food court 42; and the mobile unit m3 beside the attraction 46. The mobile units m4 and m5 may be located at the allocating station 49. Before the opening of the theme park 80, the waste containers 11 of the respective mobile units m1 to m5 are empty.

When the theme park 80 is opened, visitors enter the theme park 80. As described above with reference to FIGS. 4 and 5, visitors place waste into the waste containers 11 of the mobile units m1 to m3 located around the food courts 41, 42 and the attraction 46. The travel controllers 125 of the mobile units m1 to m3 generate a waste detection signal each time the vertically lined-up sensors 14 in the waste container 11 output waste amount information.

When time passes after the opening of the theme park 80, the amount of waste discharged from the food court 41 increases as shown in FIG. 4. The travel controller 125 of the mobile unit m1 outputs waste amount information of 25%, 50%, and 75% in this order. Similarly to the mobile unit 10 described above, the travel controller 125 may change the illumination color of the indicator 15, for example, in the order of green, yellow, and orange.

The communication device 127 outputs the waste amount information generated by the travel controller 125 to the server 30 via the communication line 35. The server 30 receives, from the mobile unit m1 located beside the food court 41, the waste amount information of 25%, 50%, and 75% in this order.

Upon receipt of the waste amount information of 75% from the mobile unit ml, the server 30 determines that the waste container 11 of the mobile unit m1 will soon be full (100% of the capacity) and sends a relocation command to the mobile unit m5 located at the allocating station 49 to travel to a location beside the food court 41. The waste container 11 of the mobile unit m5 is empty at this point. This relocation command includes location information of the destination at one of the predetermined locations.

Upon receipt of the topographic data of the theme park 80 and the location information of the food court 41 (the destination) from the server 30, the communication device 27 of the mobile unit m5 outputs these to the location sensor 26. The location sensor 26 calculates a travel route from the current allocating station 49 to the food court 41 based on the topographic data of the theme park 80 and the location information of the food court 41 inputted from the communication device 27, and outputs the calculated route to the travel controller 25. The travel controller 25 controls the drive motors 22 based on the route information inputted from the location sensor 26 to autonomously drive the mobile unit m5 to the food court 41 as shown with an arrow 91 in FIG. 6. The mobile unit m5 may travel on the roads 37 or other areas allowed for travel, such as on lawns.

When the mobile unit m5 arrives at the food court 41, the mobile unit m5 outputs an arrival signal to the server 30. Upon receipt of the arrival signal from the mobile unit m5, the server 30 outputs a relocation command to the mobile unit m1 to travel to the waste collection station 50. This relocation command includes location information of the waste collection station 50, which is the destination. Similarly as the mobile unit m5, the mobile unit m1 calculates a travel route to the waste collection station 50 based on the topographic data and the location information of the waste collection station 50 received from the server 30, and travels to the waste collection station 50 as shown with an arrow 92 in FIG. 6.

The mobile unit m1 discharges waste from the waste container 11 at the waste collection station 50. The mobile unit m1 may then autonomously travel to, for example, the allocating station 49, based on a relocation command from the server 30 and is stationed there, or to a location beside the attraction 44. The waste discharged from the mobile unit ml at the waste collection station 50 is collected by the waste collecting truck 51 at a predetermined time and transported to a waste processing facility (not shown), as shown with an arrow 95.

As described above, the waste collection system 100 can control the mobile unit 110 with the waste container 11 to travel to the waste collection station 50 based on the waste amount information received by the server 30 from the mobile unit 110, enabling the mobile unit 110 to travel to the waste collection station 50 before waste overflows from the waste container 11. This can reduce degradation of views of the theme park 80. Further, because the mobile unit 110 with the waste container 11 autonomously travels to transport waste, no work to collect waste from the waste container 11 is exposed inside the theme park 80. This can also reduce degradation of views.

Other operations of the waste collection system 100 are described below. The food court 42 shown in FIG. 6 may output, to the server 30, the amount of waste to be discharged from the food court 42 as the waste discharge information based on the amount of food and beverages that have been sold. The attraction 46 outputs, to the server 30, the amount of waste to be discharged from the attraction 46 as the waste discharge information based on the number of visitors who have visited the attraction 46. The server 30 compares the waste discharge information received from the food court 42 and the past actual data (refer to FIG. 4) of waste discharged from the food court 42 in the corresponding time slot stored in the waste discharge amount database 34. If the amount of waste to be discharged from the food court 42 exceeds the past actual data, the server 30 sends a command to the mobile unit m4 waiting at the allocating station 49 to travel to the food court 42 as shown with an arrow 93 in FIG. 6, when the amount of waste information received from the mobile unit m2 located beside the food court 42 reaches 50%, which is less than 75% described in the previous embodiment. If the waste discharge information received from the attraction 46 exceeds the past actual data of the waste discharge amount from the attraction 46 shown in FIG. 5, the server 30 sends a command to the mobile unit m4 to travel to a location beside the attraction 46.

As described above, because the server 30 can control the mobile units 110 based on the waste discharge information received from the establishment 40, such as the food court 42, and the waste discharge amount database 34, risks of waste overflow from the waste container 11 can be lowered even when the amount of waste exceeds a usual level. This can reduce degradation of views of the theme park 80.

The server 30 can control the allocation and traveling of the mobile units 110 in the theme park 80 in accordance with the time slot, the season, and/or the weather conditions. This enables effective collection of waste.

When a large event is held beside the food court 42 shown in FIG. 6, and food and beverages are sold in several times the usual amount, the food court 42 sends the waste discharge information that indicates that a large amount of waste will be discharged within one or two hours. Upon receipt of such waste discharge information from the food court 42, the server 30 determines that it will become impossible for the mobile unit m2 beside the food court 42 to collect waste all by itself, and sends a relocation command to the mobile unit m4 that is waiting at the allocating station 49 to travel to a location beside the food court 42. Upon receipt of this relocation command, the mobile unit m4 starts autonomously traveling to the food court 42 and stays beside the food court 42. This reduces risks of a shortage of the capacity of the waste container 11.

As described above, because the server 30 controls the mobile unit 110 based on the waste discharge information received from the establishments 40, such as the food court 42, risks that waste exceeds the capacity of the waste container 11 of the mobile unit 110 can be reduced even when the amount of waste rapidly increases. This can reduce degradation of views of the theme park 80. Further, the waste collection capacity can be increased by allocating the mobile unit 110 with the empty waste container 11 to a location beside the establishment 40, such as the food court 42. This enables effective collection of waste and reduces degradation of views.

In the waste collection system 100 described above, the server 30 is assumed to send, to the mobile unit 110, a relocation command (as a travel command) that includes the location information of the destination and the topographic data of the theme park 80, and the mobile unit 110 is assumed to calculate the travel route and autonomously travel to the destination. However, the present disclosure is not limited to such embodiments. For example, the server 30 may calculate the travel route between the current location of the mobile unit 110 and the destination, and send the calculated route to the mobile unit 110 to enable the autonomous traveling of the mobile unit 110. This can simplify the configuration of the mobile unit 110.

In the above description, the mobile units m1 to m5 are assumed to travel outdoors. However, the mobile units m1 to m5 may travel inside buildings, such as the food courts 41, 42, and attractions 43 to 46 by communicating with the server 30 and referring to the building data stored in the building database 33 of the server 30.

In the above embodiments, the database unit 31 of the server 30 is assumed to include the topographic database 32, the building database 33, and the waste discharge amount database 34. However, the present disclosure is not limited to such embodiments. For example, the database unit 31 may include the topographic database 32 alone, and the server 30 may control the traveling of the mobile unit 110 based on the waste amount information received from the mobile unit 110. Alternatively, the database unit 31 may include two databases, the topographic database 32 and the waste discharge amount database 34, and the server may control the traveling of the mobile unit 110 based on the waste discharge information received from the establishment 40, such as the food court 42, and the waste discharge amount database 34.

When the waste collection system 100 of the present disclosure is applied to the theme park 80, the waste transporting mobile units 10, 110 may have an appearance of a character of an attraction of the theme park 80, or the indicator 15 may have a shape of an eye or the like.

1. A waste transporting mobile unit comprising:
a waste container that collects waste;
a sensor configured to sense an amount of waste accumulated in the waste container; and
a travel device configured to travel when the amount of waste sensed by the sensor reaches a predetermined amount.

2. The waste transporting mobile unit according to claim 1, wherein
the waste transporting mobile unit further comprises an indicator configured to indicate the amount of waste sensed by the sensor, and
the indicator changes an indicated status in accordance with the amount of waste sensed by the sensor.

3. A waste transporting mobile unit comprising:
a waste container that collects waste;
a communication device configured to receive information from an external entity; and
a travel device configured to travel in accordance with the information received by the communication device.

4. A waste collection system comprising:
a server comprising a topographic database that stores topographic information of a predefined area;
a waste container that collects waste;
a sensor configured to sense, as waste amount information, an amount of waste accumulated in the waste container; and
a mobile unit configured to communicate with the server to travel within the predefined area,
wherein the mobile unit is configured to send to the sever the waste amount information sensed by the sensor, and
the server is configured to output a travel command to the mobile unit based on the waste amount information received from the mobile unit.

5. The waste collection system according to claim 4, further comprising:
an establishment located in the predefined area and configured to communicate with the server to output waste discharge information to the server,
wherein the server is configured to output the travel command to the mobile unit based on the waste discharge information received from the establishment.

6. The waste collection system according to claim 4, wherein
the server comprises a waste discharge amount database in which a past waste discharged amount in the predefined area is stored with association with a time slot, a season, and/or weather conditions, and
the server is configured to output the travel command to the mobile unit based on the waste discharge amount database.

7. The waste collection system according to claim 4, wherein
the travel command is a relocation command to a predetermined location, and
the mobile unit autonomously travels to the predetermined location based on topographic data of the predefined area and location information of the predetermined location received from the server.

8. The waste collection system according to claim 5, wherein
the travel command is a relocation command to a predetermined location, and
the mobile unit autonomously travels to the predetermined location based on topographic data of the predefined area and location information of the predetermined location received from the server.

9. The waste collection system according to claim 6, wherein
the travel command is a relocation command to a predetermined location, and
the mobile unit autonomously travels to the predetermined location based on topographic data of the predefined area and location information of the predetermined location received from the server.

10. The waste collection system according to claim 4, wherein
the travel command comprises a travel route to a predetermined location, and
the mobile unit autonomously travels to the predetermined location based on the travel route received from the server.

11. The waste collection system according to claim 5, wherein
the travel command comprises a travel route to a predetermined location, and
the mobile unit autonomously travels to the predetermined location based on the travel route received from the server.

12. The waste collection system according to claim 6, wherein
the travel command comprises a travel route to a predetermined location, and
the mobile unit autonomously travels to the predetermined location based on the travel route received from the server.

13. The waste collection system according to claim 4, wherein
the mobile unit comprises an indicator configured to indicate the amount of waste sensed by the sensor, and
the indicator is configured to change an indicated status in accordance with the amount of waste sensed by the sensor.

14. The waste collection system according to claim 5 wherein
the mobile unit comprises an indicator configured to indicate the amount of waste sensed by the sensor, and
the indicator is configured to change an indicated status in accordance with the amount of waste sensed by the sensor.

15. The waste collection system according to claim 6, wherein
the mobile unit comprises an indicator configured to indicate the amount of waste sensed by the sensor, and
the indicator is configured to change an indicated status in accordance with the amount of waste sensed by the sensor.

16. The waste collection system according to claim 7, wherein
the mobile unit comprises an indicator configured to indicate the amount of waste sensed by the sensor, and
the indicator is configured to change an indicated status in accordance with the amount of waste sensed by the sensor.

17. The waste collection system according to claim 8, wherein
the mobile unit comprises an indicator configured to indicate the amount of waste sensed by the sensor, and
the indicator is configured to change an indicated status in accordance with the amount of waste sensed by the sensor.

18. The waste collection system according to claim 9, wherein
the mobile unit comprises an indicator configured to indicate the amount of waste sensed by the sensor, and
the indicator is configured to change an indicated status in accordance with the amount of waste sensed by the sensor.

19. The waste collection system according to claim 10, wherein
the mobile unit comprises an indicator configured to indicate the amount of waste sensed by the sensor, and
the indicator is configured to change an indicated status in accordance with the amount of waste sensed by the sensor.

20. The waste collection system according to claim 11, wherein
the mobile unit comprises an indicator configured to indicate the amount of waste sensed by the sensor, and
the indicator is configured to change an indicated status in accordance with the amount of waste sensed by the sensor.

21. The waste collection system according to claim 12, wherein
the mobile unit comprises an indicator configured to indicate the amount of waste sensed by the sensor, and
the indicator is configured to change an indicated status in accordance with the amount of waste sensed by the sensor.
